(19) United States
(12) Patent Application Publication
(10) Pub. No.: US 2026/0160097 A1
(43) Pub. Date: Jun. 11, 2026

(54) FURNITURE STORAGE UNIT WITH INTERLOCK MECHANISM FOR TOPPLING PREVENTION

(71) Applicant: Seng Ann ONG, Klang (MY)

(72) Inventor: Seng Ann ONG, Klang (MY)

(21) Appl. No.: 19/414,320

(22) Filed: Dec. 10, 2025

(30) Foreign Application Priority Data
Dec. 11, 2024 (MY) PI2024007141

(51) Int. Cl. E05B 65/463

(52) U.S. Cl. CPC E05B 65/463

(57) ABSTRACT

The invention discloses an anti-toppling furniture storage unit (1) comprises a plurality of drawers (20), each supported by at least one roller slide mechanism in such a way that the drawers (20) are slidable between an open position and a closed position; and an interlock mechanism configured to allow one of the drawers (20) to move to the open position while simultaneously locking the remaining drawers (20) in the closed position.

### TECHNICAL FIELD

The invention relates to a furniture assembly. More particularly, the invention relates to a furniture storage unit with interlock mechanism for preventing toppling of the storage unit.

### BACKGROUND

Furniture tip-over incidents represent a significant safety hazard, particularly to children, often resulting in serious injury or even fatalities. Such incidents typically occur when furniture items, such as dressers, chests, or television cabinets, become unstable and topple over, causing harm to nearby individuals. The consequences can range from minor abrasions and contusions to severe injuries, including fractures, traumatic brain injuries, and asphyxiation.

Statistical data highlights the alarming frequency of such events, with thousands of children affected annually. The underlying causes are multifaceted and include unstable furniture designs, insufficient anchoring or securing of furniture, the placement of excessively heavy items, and the natural inclination of children to climb or interact with their surroundings. Contributing factors also include the use of lightweight or structurally inadequate materials in furniture production, cost-saving measures that compromise stability, insufficiently clear warning labels, and a general lack of awareness among caregivers.

A potential solution to mitigate the risk of tip-overs is the integration of a safety mechanism that permits only one drawer to open at a time, with all remaining drawers securely locked. By preventing the simultaneous opening of multiple drawers, this mechanism ensures balanced weight distribution, significantly reducing the likelihood of the furniture becoming top-heavy or unstable.

A variety of safety mechanisms have been suggested in the past, an example of which can be found in the disclosure of United States Patent Application No. US20180066454A1. The patent discloses an anti-toppling drawer chest comprises a plurality of drawers arranged within a chest body, wherein an anti-toppling interlock mechanism is provided between the side wall of the chest body and the drawers. The interlock mechanism includes fixing elements mounted on the side wall of the chest body, a sliding rod positioned between the fixing elements and the chest body side wall, and stop blocks affixed to the side walls of the drawers. The stop blocks are configured with inclined slideways, along which the sliding rod and associated clamping tenons move when the drawers are opened or closed. This configuration enables the anti-toppling drawer chest to achieve the functionality of allowing only one drawer to be opened at a time while the remaining drawers remain securely locked.

While the disclosed interlock mechanism offers a straightforward approach to preventing the toppling of a drawer chest, its installation process may be complex and prone to errors. Such challenges during assembly can lead to improper installation, potentially compromising the functionality and reliability of the interlock mechanism. Furthermore, the interlock mechanism relies on a fixing element to secure the sliding rod in position. However, this design is susceptible to wear and tear over time, which can compromise the integrity of the fixing element and lead to potential failure of the interlock mechanism.

Accordingly, it would be desirable to provide an interlock mechanism that addresses the aforementioned issue. This invention provides to an anti-toppling furniture storage unit.

### SUMMARY

According to a first embodiment of the invention, there is provided an anti-toppling furniture storage unit comprises a plurality of drawers, each supported by at least one roller slide mechanism in such a way that the drawers are slidable between an open position and a closed position; and an interlock mechanism configured to allow one of the drawers to move to the open position while simultaneously locking the remaining drawers in the closed position; characterised in that the interlock mechanism comprises: an elongate lock member supported within the storage unit and being slidable between a locked position, an unlock position, and a drawer assembling position; a spring-loaded member, engaged with a portion of the elongate lock member, biasing the elongate lock member toward the unlock position from the drawer assembling position; and a plurality of engaging members distributed along a length of the elongate lock member and extended outwardly from the elongate lock member; wherein each engaging member comprises a first slanted surface, engageable during a drawer assembling process by a first roller slide member extending from a drawer, to move the elongate lock member to the drawer assembling position, such that the first roller slide member is guided by the engaging member in the drawer assembling position to slidably engage and connect with a corresponding second roller slide member extending from a panel of the storage unit.

According to this embodiment, the interlock mechanism may further comprise a plurality of stopper members, each extending from a drawer.

According to this embodiment, each engaging member may comprise a second slanted surface opposing the first slanted surface, engageable by the first roller slide member of a corresponding drawer moving toward the open position, to move the elongate lock member to the locked position, such that the engaging members are positioned to obstruct the path of the stopper members of the remaining drawers which are in the closed position.

According to this embodiment, the engaging member may be lifted by the first roller slide member to the locked position when the corresponding drawer moves to the open position, and the engaging member returns to the unlock position via gravity when the corresponding drawer moves to the closed position.

According to this embodiment, when the corresponding drawer moves toward the closed position, the stopper member of the corresponding drawer may engage the first slanted surface of the engaging member in the locked position to move the elongate lock member to the unlock position.

According to this embodiment, the first and second slanted surfaces of each engaging member may be inclined upwardly at a predetermined angle from an external side toward an internal side of the storage unit.

According to this embodiment, the elongate lock member can be slidable within a groove of the storage unit.

According to this embodiment, the spring-loaded member may comprise a body having a channel with an open end and a closed end, a movable member positioned adjacent the open end and being slidable within the channel, and a coil spring disposed within the channel, and being positioned between the movable member and the closed end to bias the movable member towards the open end.

According to this embodiment, the channel may be divided into two portions, a first portion terminating at the open end and a second portion terminating at the closed end, the first portion is cross-sectionally narrower than the second portion such that a step is formed at the intersection between the first and second portions.

According to this embodiment, the movable member may have a length extending from the open end, through the first portion, into the second portion of the channel, and the movable member may comprise a protruded portion that are engageable with the step to prevent detachment of the movable member from the channel.

One skilled in the art will readily appreciate that the invention is well adapted to carry out the objects and obtain the ends and advantages mentioned, as well as those inherent therein. The embodiments described herein are not intended as limitations on the scope of the invention.

### BRIEF DESCRIPTION OF THE DRAWINGS

For the purpose of facilitating an understanding of the invention, there is illustrated in the accompanying drawing the preferred embodiments from an inspection of which when considered in connection with the following description, the invention, its construction and operation and many of its advantages would be readily understood and appreciated.

FIG. 1 is a side see-through view diagram of an anti-toppling furniture storage unit before the installation of its drawers.

FIG. 2 is a side see-through view diagram illustrating the process of assembling a drawer into the storage unit.

FIG. 3 is a side see-through view diagram illustrating the assembled drawers in their closed position.

FIG. 4 is a side see-through view diagram illustrating the operation of an interlock mechanism of the storage unit.

FIG. 5 is an enlarged view diagram illustrating an instance of a corresponding drawer moving toward its closed position from an open position.

FIG. 6a is a cross-sectional view diagram illustrating a spring-loaded member in an extended configuration.

FIG. 6b is a cross-sectional view diagram illustrating the spring-loaded member in a compressed configuration.

FIG. 7a is a front view diagram illustrating an engaging member of the interlock mechanism.

FIG. 7b is a perspective diagram of the engaging member.

### DETAILED DESCRIPTION

Hereinafter, the invention shall be described according to the preferred embodiments of the present invention and by referring to the accompanying description and drawings. However, it is to be understood that limiting the description to the preferred embodiments of the invention is merely to facilitate discussion of the present invention and it is envisioned that those skilled in the art may devise various modifications without departing from the scope of the appended claim.

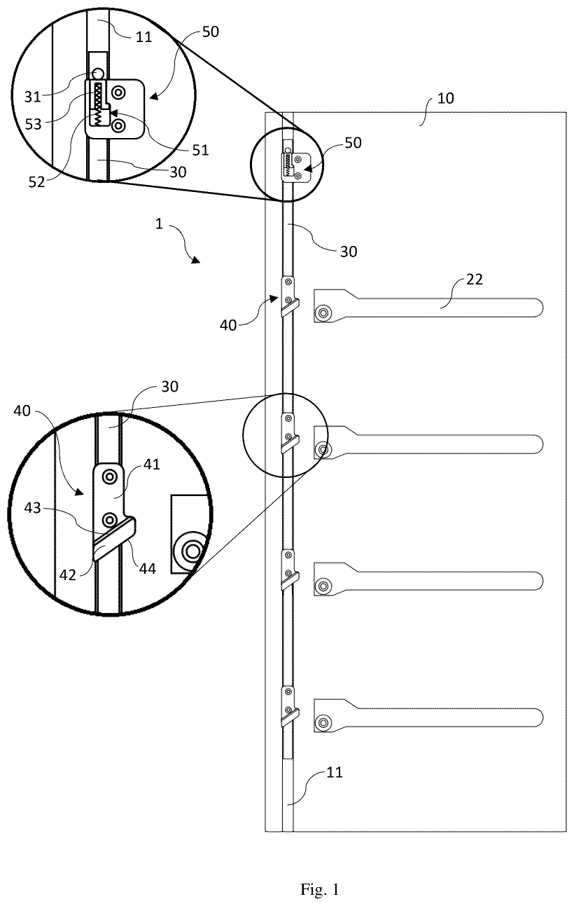

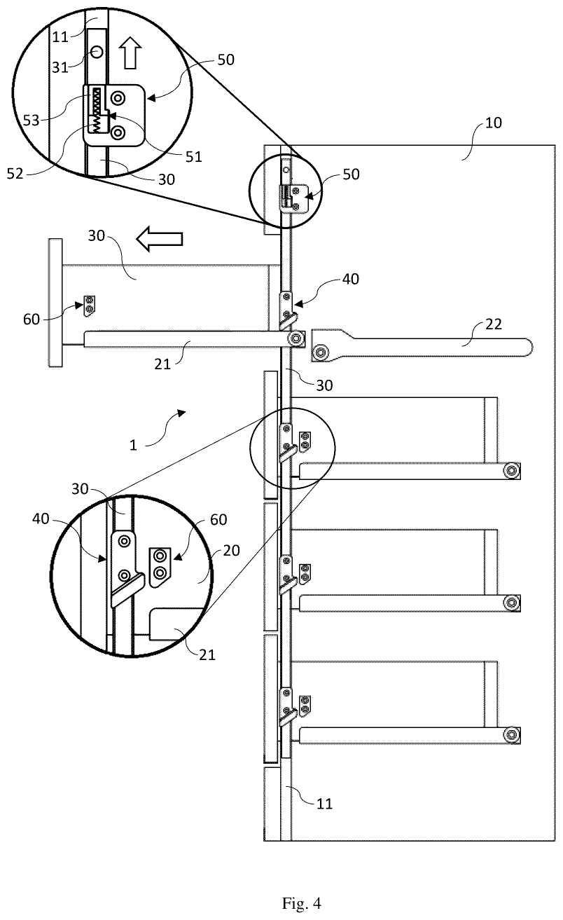

Referring to FIGS. 1 to 4, a furniture storage unit 1 as illustrated therein generally comprises a plurality of drawers 20 and an interlock mechanism for ensuring that when one of the drawers 20 is moved to an open position, the remaining drawers 20 are locked in a closed position. The furniture storage unit 1 may include but is not limited to cabinet, shelving units, chests, closet, modular units. Preferably, the drawers 20 are horizontally arranged one on top of another. Each drawer 20 includes at least one roller slide mechanism that enables the drawer 20 to move, in a substantially horizontal manner, between the opened position where the drawer is accessible, and the closed position where the drawer cannot be accessed. Nevertheless, it should be noted that the roller slide mechanism can be easily replaced by other drawer slide mechanism such as under-mount slider, centre-mount slider, ball bearing slider, or any combination thereof.

In the preferred embodiment, the roller slide mechanism comprises a first roller slide member 21 attached to a side panel of the drawers 20, and a second roller slide member 22 attached to a side panel 10 of the storage unit 1. The first and second roller slide members 21, 22 may be secured to their respective panels using screws. Nonetheless, it is understood that other commercially available fastening mechanisms may be used as alternatives. The first roller slide member 21 engages with and is guided by the second roller slide member 22 to facilitate the sliding movements of the corresponding drawer 20. To minimize friction, each roller slide member 21, 22 may incorporate at least one wheel. In one specific configuration, the wheel of the first roller slide member 21 is located at its rear end, while the wheel of the second roller slide member 22 is located at its front end.

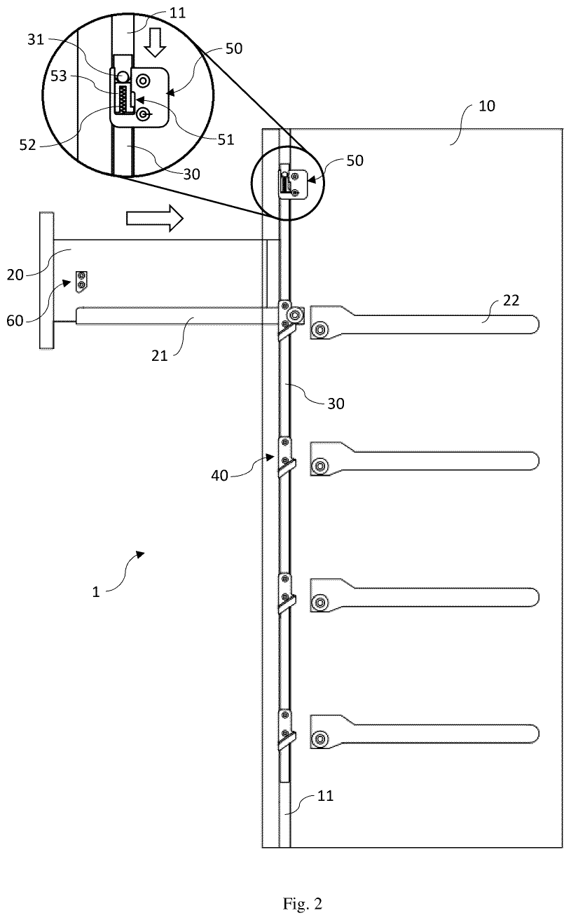

The interlock mechanism comprises an elongate lock member 30, a spring-loaded member 50, a plurality of engaging members 40, and a plurality of stopper members. The elongate lock member 30 is slidably supported within the storage unit 1 and is configured to move between a locked position, an unlock position, and a drawer assembling position. The elongate lock member 30 can be made of metal. In one embodiment, a groove 11 is formed on the inner surface of the side panel 10 of the storage unit 1, with dimensions specifically configured to accommodate the elongate lock member 30. This configuration allows the elongate lock member 30 to slide smoothly between the designated positions, as illustrated in FIGS. 2 to 4. Alternatively, one or more holding members may be employed in place of the groove 11, providing direct support for the elongate lock member 30 on the inner side of the side panel 10. While the elongate lock member 30 is depicted as a one-piece body, it should be noted that the body can also be constructed using multiple interconnected segments, which exhibit synchronized movements between the designated positions.

In the preferred embodiment, the spring-loaded member 50 is mounted on the inner surface of the side panel 10 of the storage unit 1 to prevent the elongate lock member 30 from disengaging from the groove 11, thereby ensuring its movement is confined to only between the designated positions. The spring-loaded member 50 is configured to engage with a protruded portion 31 of the elongate lock member 30, biasing the elongate lock member 30 toward the unlock position, as shown in FIGS. 1 & 3, from the drawer assembling position as shown in FIG. 2. The protruded portion 31 can be affixed to the elongate body 30 either through welding or by screw attachment. Alternatively, the spring-loaded member 50 can be integrated within the groove 11 of the storage unit 1 to engage with an end portion of the elongate lock member 30.

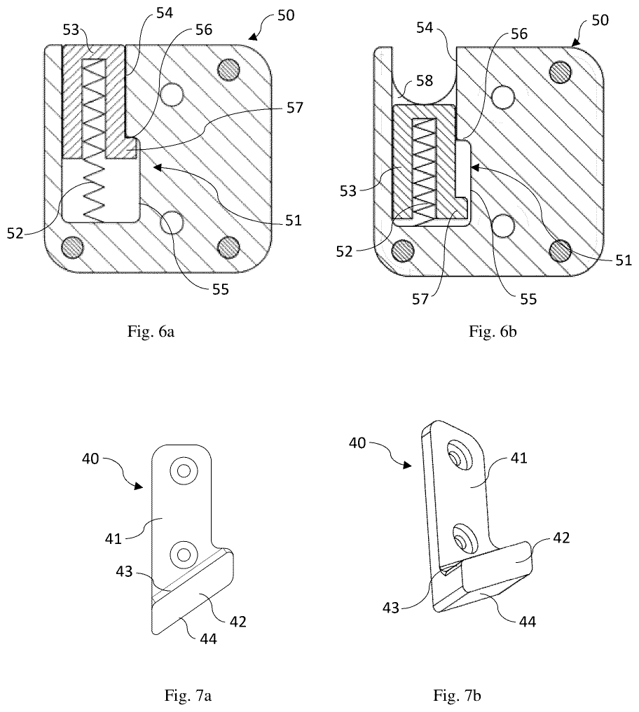

Referring to FIGS. 6a & 6b, the spring-loaded member 50 comprises a body having a channel 51, a movable member 53, and a coil spring 52. The channel 51 is divided into two sections: a first section 54 terminating at an open end and a second section 55 terminating at a closed end. The first section 54 is cross-sectionally narrower than the second section 55, forming a step 56 at their intersection. The movable member 53 is slidably positioned within the channel 51 and configured to move between an extended position, as illustrated in FIG. 6a, and a compressed position, as illustrated in FIG. 6b. The movable member 53 extends longitudinally from the open end, through the first section 54, and into the second section 55. Its length is dimensioned to allow sufficient sliding space within the second section 55. Additionally, the movable member 53 includes an extended portion 57 located within the second section 55, which engages with the step 56 to prevent detachment from the channel 51.

The coil spring 52 is positioned within the channel 51, between the movable member 53 and the closed end. The coil spring 52 biases the movable member 53 toward the extended configuration. An external force acting upon the movable member 53 will move it toward the compressed configuration. In one specific embodiment, the movable member 53 includes a recess for accommodating an end portion of the coil spring 52 or the entire coil spring 52 during the compressed configuration. The body and movable member 53 of the spring-loaded member 50 can be made of plastic material, while the coil spring 52 is made of metal. The spring constant of the coil spring 52 may vary based on the weight of the elongate lock member 30, the attached members and the friction between the elongate lock member 30 and the groove 11. The movable member 53 is further configured to engage the protruded portion 31 of the elongate lock member 30. The channel includes a recessed wall 58 that allows the protruded portion 31 of the elongate lock member 30 to enter the channel 51 only to an extent where it engages the recessed wall 58.

In the embodiment where the spring-loaded member 50 is integrated into the groove 11 of the storage unit 1, at least one end portion of the groove 11 is shaped to resemble the channel 51, allowing it to accommodate the movable member 53 and the coil spring 52. In this configuration, the body of the spring-loaded member 50 can be omitted. Alternatively, the coil spring 52 can be replaced by magnets which repel each other with a force comparable to the compression strength of the coil spring 52.

In one preferred embodiment, the engaging members 40 are distributed in a lengthwise manner along the elongate lock member 30. Each engaging member 40 is positioned adjacent to the first roller slide member 21 of their corresponding drawers 20 or at a location that obstructs the sliding pathway of the first roller slide member 21. Referring to FIGS. 7a & 7b, each engaging member 40 comprises a first body section 41 with one or more through-holes for screw attachment to the elongate lock member 30, and a second body section 42 extending outwardly perpendicular to the first body section 41 and in a direction towards its corresponding drawer 20. The second body section 42 is inclined upwardly at a predetermined angle from an external side toward an internal side of the storage unit 1. The second body section 42 includes a first slanted surface 43 and a second slanted surface 44. Preferably, the first slanted surface 43 is located above the second slanted surface 44.

During a drawer assembling process, as shown in FIG. 2, the first slanted surface 43 is engageable by the first roller slide member 21, introducing a downward force that moves the elongate lock member 30 to the drawer assembling position and simultaneously causes the spring-loaded member 50 to be in the compressed configuration. In the drawer assembling position, the engaging member 40 is displaced to reveal a pathway, allowing the first roller slide member 21 to be guided into slidable engagement with a corresponding second roller slide member 22. When the drawer 20 is in the closed position, the first roller slide member 21 disengages from the engaging member 40. This disengagement allows the spring-loaded member 50 to push the elongate lock member 30 upward, returning the elongate lock member 30 to the unlock position. This arrangement enables the drawers 20 to be assembled into the storage unit 1 without requiring manual adjustment of the elongate lock member 30. The elongate lock member 30 is moved automatically to the desired position during the drawer assembly process.

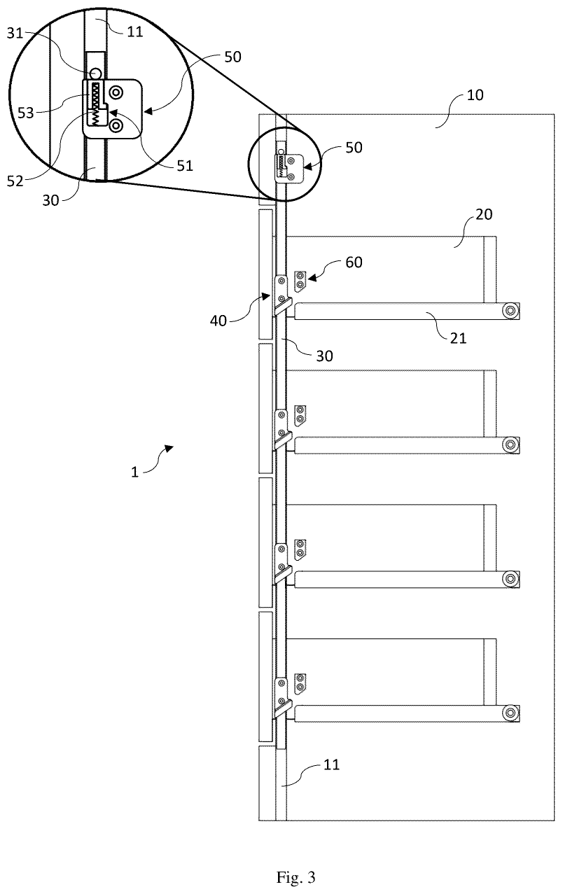

Referring to FIGS. 3 & 4, each stopper member 60 is attached to the side panel of a corresponding drawer 20, at a location above the first roller slide member 21. When the elongate lock member 30 is in the locked position, the corresponding engaging members 40 obstruct the movement pathways of the stopper members 60. Conversely, when the elongate lock member 30 is in the unlocked position, the engaging members no longer obstruct these pathways.

In operation, when a drawer 20 is moved from the closed position to the open position, the first roller slide member 21 of that drawer 20 engages the second slanted surface 44 of the corresponding engaging member 40, introducing an upward force that moves the elongate lock member 30 to the locked position. The movement of the elongate lock member 30 occurs either simultaneously with or immediately after the stopper member 60 of that drawer 20 passes the corresponding engaging member 40. In the locked position, the second body section 42 of the engaging members 40 are displaced to obstruct the pathways of the stopper members 60 of the remaining drawers 20, effectively preventing the remaining drawers 20 from opening. A front portion of each first roller slide member 21 may comprise a slanted surface, that matches the inclined angle of the second slant surface 44 of each engaging member 40, to facilitate a smooth transition and enable the elongate lock member 30 to be lifted in an efficient manner. The body of the spring-loaded member 50 including the movable member 53, the engaging members 40 and the stopper members 60 can be fabricated through a plastic injection moulding process.

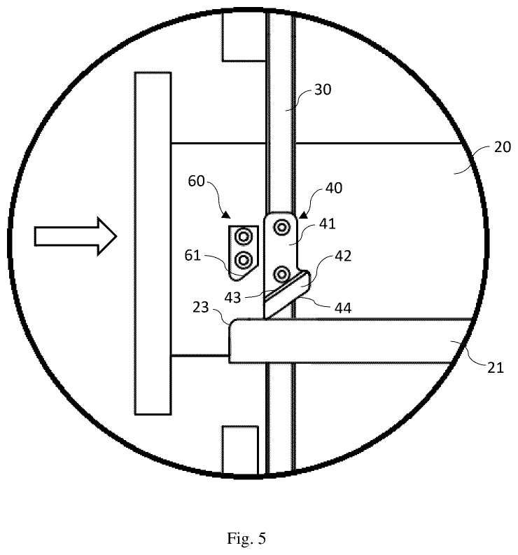

When the drawer 20 returns from the open position to the closed position as shown in FIG. 5, the first roller slide member 21 of that drawer 20 no longer supports the lifted elongate lock member 30 when it reaches the closed position. Consequently, the engaging lock member 30 returns to the unlock position under the influence of gravity. In this embodiment, a weight may be attached to the elongate lock member 30 to ensure that its overall weight is sufficient to overcome the friction between the elongate lock member 30 and the groove 11. Alternatively, the stopper member 60 of the corresponding drawer may engage the first slanted surface 43 of the engaging member 40, in the locked position, to move the elongate lock member 30 to the unlock position. The stopper member 60 may include a slanted surface 61 matching the inclined angle of the first slant surface 43 of the engaging member 40. This arrangement ensures a smooth transition and allows the elongate lock member 30 to be pushed downward efficiently.

The present disclosure includes as contained in the appended claims, as well as that of the foregoing description. Although the invention has been described and illustrated in detail, it is to be understood that the same is by the way of illustration and example, and is not to be taken by way of limitation. The scope of the present invention is to be limited only by the terms of the appended claims.

1. An anti-toppling furniture storage unit (1) comprising:
a plurality of drawers (20), each supported by at least one roller slide mechanism in such a way that the drawers (20) are slidable between an open position and a closed position; and
an interlock mechanism configured to allow one of the drawers (20) to move to the open position while simultaneously locking the remaining drawers (20) in the closed position;
wherein each roller slide mechanism includes a first roller slide member (21) attached to a corresponding drawer (20), and a second roller slide member (22) attached to a panel (10) of the storage unit (1);
characterised in that the interlock mechanism comprises:
an elongate lock member (30) supported within the storage unit (1) and being slidable between a locked position, an unlock position, and a drawer assembling position;
a spring-loaded member (50), engaged with a portion of the elongate lock member (30), biasing the elongate lock member (30) toward the unlock position from the drawer assembling position; and
a plurality of engaging members (40) distributed along a length of the elongate lock member (30) and extended outwardly from the elongate lock member (30);
wherein each engaging member (40) comprises a first slanted surface (43), engageable by the first roller slide member (21) during a drawer assembling process, to move the elongate lock member (30) to the drawer assembling position, such that the first roller slide member (21) is guided by the engaging member (40) in the drawer assembling position to slidably engage and connect with the corresponding second roller slide member (22).

2. The anti-toppling furniture storage unit (1) according to claim 1, wherein the interlock mechanism further comprises a plurality of stopper members (60), each extending from a drawer (20).

3. The anti-toppling furniture storage unit (1) according to claim 2, wherein each engaging member (40) comprises a second slanted surface (44) opposing the first slanted surface (43), engageable by the first roller slide member (21) of a corresponding drawer (20) moving toward the open position from the closed position, to move the elongate lock member (30) to the locked position, such that the engaging members (30) are positioned to obstruct the path of the stopper members (60) of the remaining drawers (20) which are in the closed position.

4. The anti-toppling furniture storage unit (1) according to claim 3, wherein the engaging member (40) is lifted by the first roller slide member (21) to the locked position when the corresponding drawer (20) moves to the open position, and the engaging member (40) returns to the unlock position via gravity when the corresponding drawer (20) moves to the closed position.

5. The anti-toppling furniture storage unit (1) according to claim 3, wherein when the corresponding drawer (20) moves toward the closed position from the open position, the stopper member (60) of the corresponding drawer (20) engages the first slanted surface (43) of the engaging member (40) in the locked position to return the elongate lock member (30) back to the unlock position.

6. The anti-toppling furniture storage unit (1) according to claim 3, wherein the first and second slanted surfaces of each engaging member (40) are inclined upwardly at a predetermined angle from an external side toward an internal side of the storage unit (1).

7. The anti-toppling furniture storage unit (1) according to claim 1, wherein the elongate lock member (30) is slidable within a groove (11) of the storage unit (1).

8. The anti-toppling furniture storage unit (1) according to claim 1, wherein the spring-loaded member (50) comprises a body having a channel (51) with an open end and a closed end, a movable member (53) positioned adjacent the open end and being slidable within the channel (51), and a coil spring (52) disposed within the channel (51), and being positioned between the movable member (53) and the closed end to bias the movable member (53) towards the open end.

9. The anti-toppling furniture storage unit (1) according to claim 8, wherein the channel (51) is divided into two portions (54, 55), a first portion (54) terminating at the open end and a second portion (55) terminating at the closed end, the first portion (54) is cross-sectionally narrower than the second portion (55) such that a step (56) is formed at the intersection between the first and second portions (54, 55).

10. The anti-toppling furniture storage unit (1) according to claim 9, wherein the movable member (53) has a length extending from the open end, through the first portion (54), into the second portion (55) of the channel (51), and the movable member (53) comprises a protruded portion (57) that are engageable with the step (56) to prevent detachment of the movable member (53) from the channel (51).
